(19) United States
(12) Patent Application Publication
(10) Pub. No.: US 2014/0019588 A1
(43) Pub. Date: Jan. 16, 2014

(54) Distributed Local Text, Audio and Video And Application-Specific Messaging Service With Video Recording In A Battery-Operated Wireless Mobile Data Server With Removable Solid-State Memory Modules

(71) Applicants: Dagan X. Packman, Longmont, CO (US); Steven B. Volk, Boulder, CO (US)

(72) Inventors: Dagan X. Packman, Longmont, CO (US); Steven B. Volk, Boulder, CO (US)

(73) Assignee: VMO SYSTEMS INC., Boulder, CO (US)

(21) Appl. No.: 13/941,691

(22) Filed: Jul. 15, 2013

Related U.S. Application Data
(60) Provisional application No. 61/672,101, filed on Jul. 16, 2012.

(51) Int. Cl. H04L 12/24

(52) U.S. Cl. CPC H04L 41/50
USPC 709/217; 709/223

(57) ABSTRACT

A software application messaging service running on a battery operated, wireless mobile data server with an application processing environment and a relational database management system and removable solid-state memory for the distribution and recording of content accessible from clients consisting of multiple mobile devices such as smartphones, tablet computers, notebook computers and other mobile computing devices. Whereby this software messaging service enables software applications located on client devices to send and receive messages on a one-to-one, one-to-many, one-to-all, none-to-one, none-to-many or none-to-all basis, where the distribution of the message is determined by the software service via parsing of the message to identify intended client recipients.

### CROSS-REFERENCE TO RELATED APPLICATION

This application claims the priority of provisional Application No. 61/672,101, filed Jul. 16, 2012, which is incorporated herein by reference in its entirety.

### BACKGROUND OF THE INVENTION

1. Field of the Invention

The invention relates in general to a method of creating and distributing messages between software running on client devices where each client device is connected wirelessly to a battery operated wireless mobile data server. The method utilizes a unique message communication protocol where each software component implements portions or all of the communication protocol in order to create, transmit, process and receive messages.

2. Description of the Related Art

As mobile devices such as smartphones and tablet computers proliferate and depend on software applications to perform various functions, there is a requirement for wirelessly distributing messages between software running on local devices where each device is connected to a wireless mobile communication hub for mobile workers, military and defense personnel and law enforcement without the dependency on a cellular infrastructure or other externally connected network interfaces. Often times, in the case of military operations, natural disasters, field, data collection or remote workers, cellular networks or other externally connected network interfaces do not exist, are not capable of transmitting and receiving messages intended for nearby devices or those cellular networks or other externally connected network interfaces do not have the required level of security.

### SUMMARY OF THE INVENTION

In an embodiment, a software application running on a mobile client device connected to a wireless mobile data server creates a message with an identifier of the intended recipient or a list of identifiers fur the intended recipients or an instruction to distribute the message to all available recipients and transmits the message to the software application service running on the wireless data server. The software application service on the wireless mobile data server receives the message, processes it and distributes it to the intended recipients. The software applications running on the intended recipients receive the message.

In another embodiment, the software application service running on the wireless mobile data server automatically creates a message and distributes it to the intended recipient or intended recipients.

### BRIEF DESCRIPTION OF THE DRAWINGS

FIG. 1 is a block diagram of the location of necessary software applications.

FIG. 2 is a block diagram of the initial transmission, processing by the software service and subsequent delivery transmission of one type of message (one-to-one).

FIG. 3 is a block diagram of the initial transmission, processing by the software service and subsequent delivery transmission of one type of message (one-to-many),

FIG. 4 is a block diagram of the initial transmission, processing by the software service and subsequent delivery transmission of one type of message (one-to-all).

FIG. 5 is a block diagram of the initial creation by the software service and subsequent delivery transmission of one type of message (none-to-one).

FIG. 6 is a block diagram of the initial creation by the software service and subsequent delivery transmission of one type of message (none-to-many).

FIG. 7 is a block diagram of the initial creation by the software service and subsequent delivery transmission of one type of message (none-to-all).

### DETAILED DESCRIPTION OF THE INVENTION

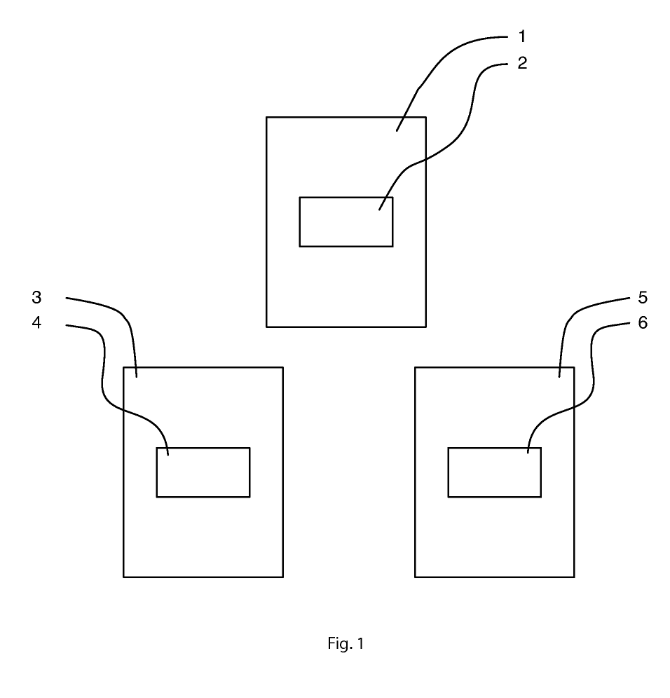

Referring, to FIG. 1, a software application messaging service 2 running on a battery operated, wireless mobile data server 1 with an application processing environment and a relational database management system and removable solid-state memory for the distribution and recording of content accessible from clients 3,5 consisting of multiple mobile devices such as smartphones, tablet computers, notebook computers and other mobile computing devices. Whereby this software messaging service 2 enables software applications 4,6 located on client devices 3,5 to send and receive messages on a one-to-one, one-to-many, one-to-all. none-to-one, none-to-many or none-to-all basis, where the distribution of the message is determined by the software messaging service via parsing of the message to identify intended client recipients. Messages can originate from any client, irrespective of the mobile devices' operating system and messages can originate from the wireless mobile data server. A message originating from a client 3,5 will contain a header section and a content section, where the header section contains instructions for the software messaging service application 2 specifying the intended recipients and where the content section contains the message content that the software service will distribute. The message content section may contain text and/or binary data or be encrypted. Messages are transmitted amongst devices wirelessly. Messages originating from a client device 3,5 may be created by the user within the client device messaging application 4,6 or may be created automatically by the client device messaging application, prior to the client device application sending the message. Messages originating from the wireless mobile data server 1 may be created automatically by the software messaging application service 2 or they may be created when the software application service 2 receives other messages from any other client devices 3,5.

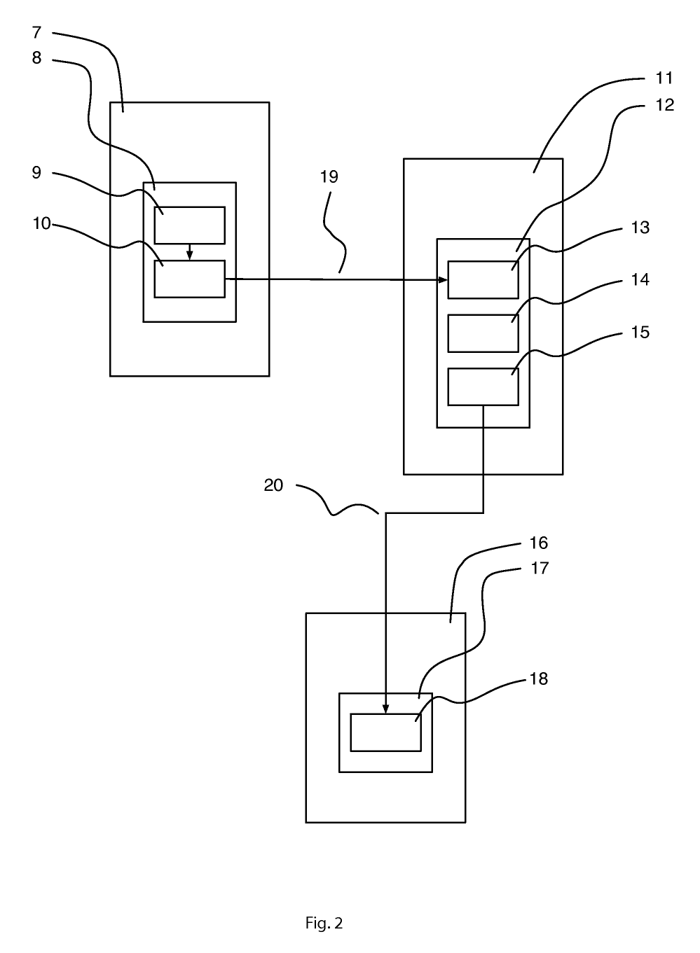

In FIG. 2, the message 19 is initiated by message creator 9 and transmitted by message sender 10 in the client messaging software application 8 in client device one 7 and is intended for client device 16. The message 19 is received by the messaging receiver 13, processed by the messaging processor 14 and sent by the wireless messaging transmitter 15 in the software messaging application 12 within wireless mobile data server 11. The transmitted message 20 is sent to client device 16. This is an example of a one-to-one messaging service.

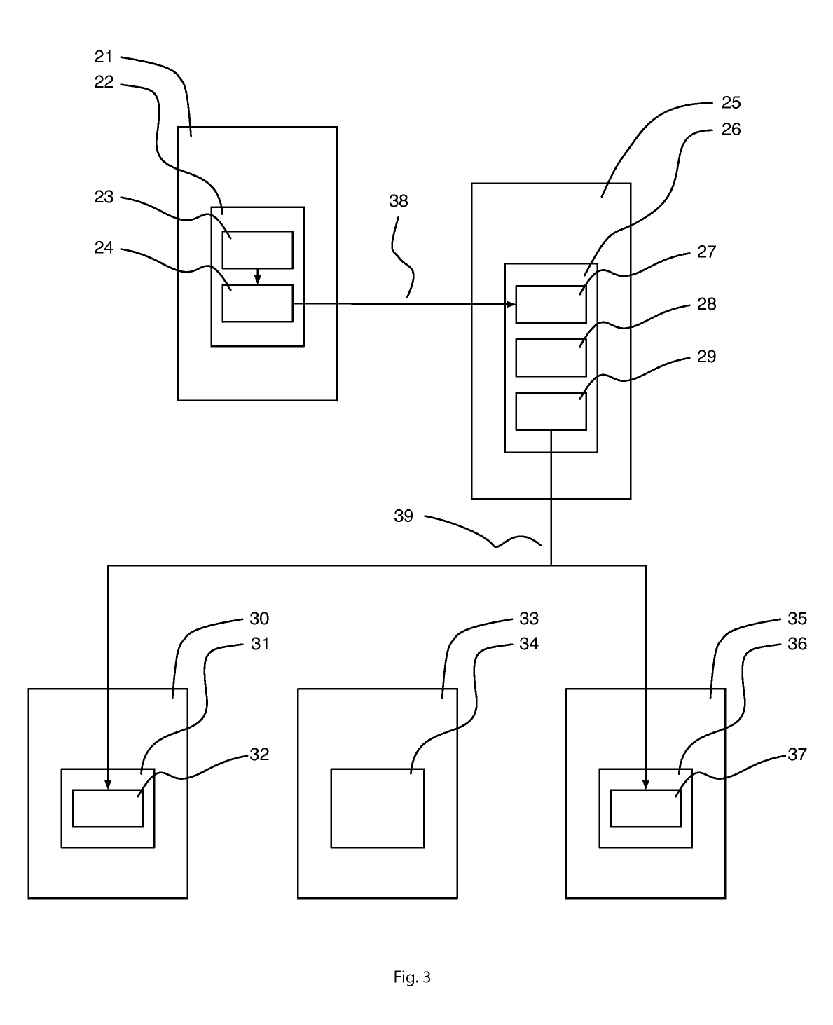

FIG. 3 illustrates a message 38 intended for two client devices 30,35 initiated by the message creator 23 and sent wirelessly by the message sender 24 in the client software messaging application 22 in client device 21. The message 38 is received by the messaging receiver 27, processed by the messaging processor 28 and sent by the wireless messaging transmitter 29 in the software messaging application 26 within wireless mobile data server 25. The transmitted message 39 is sent to client device 30 and client device four 35. This is an example of a one-to-many messaging service.

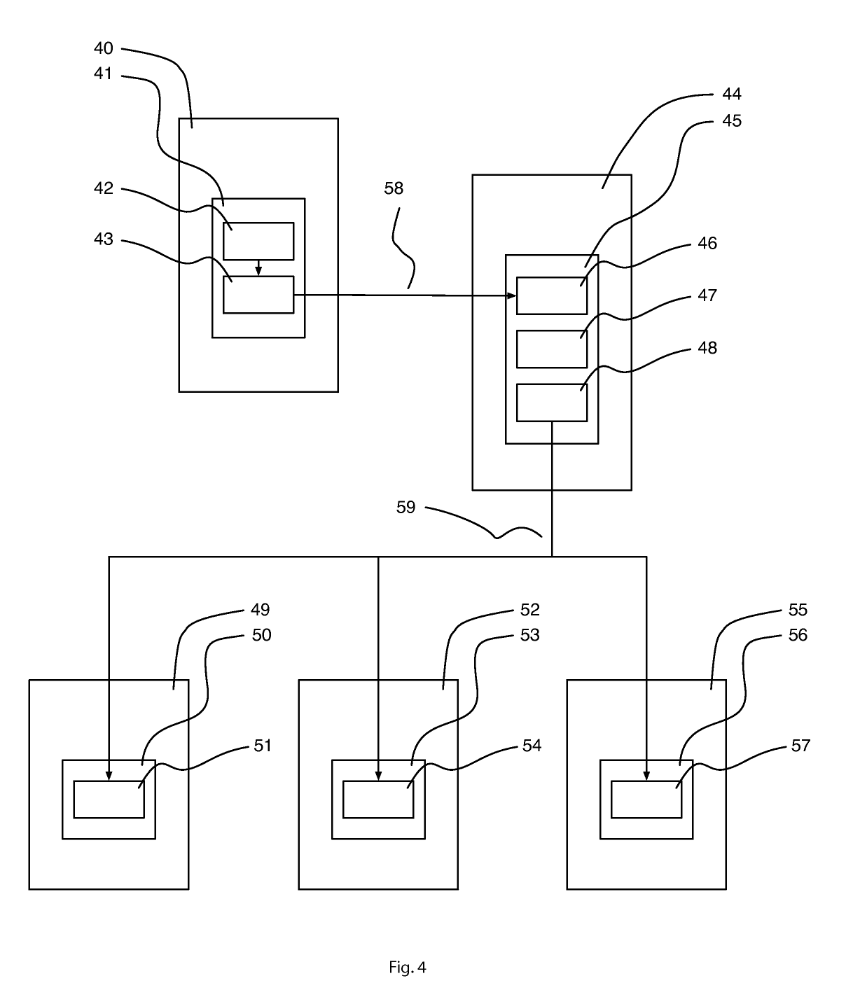

FIG. 4 illustrates a message 58 intended for all clients initiated by message creator 42 and then wirelessly transmitted by message transmitter 43 in the client software messaging application 41 in client device 40. The message 58 is received by the messaging receiver 46, processed by the messaging processor 47 and sent by the wireless messaging transmitter 48 in the software messaging application 45 within wireless mobile data server 44. The transmitted message 59 is sent to all mobile clients 49,52,55 and received in the message receptors 51,54,57 in the software message application 50,53,56 of client devices 49,52,55.

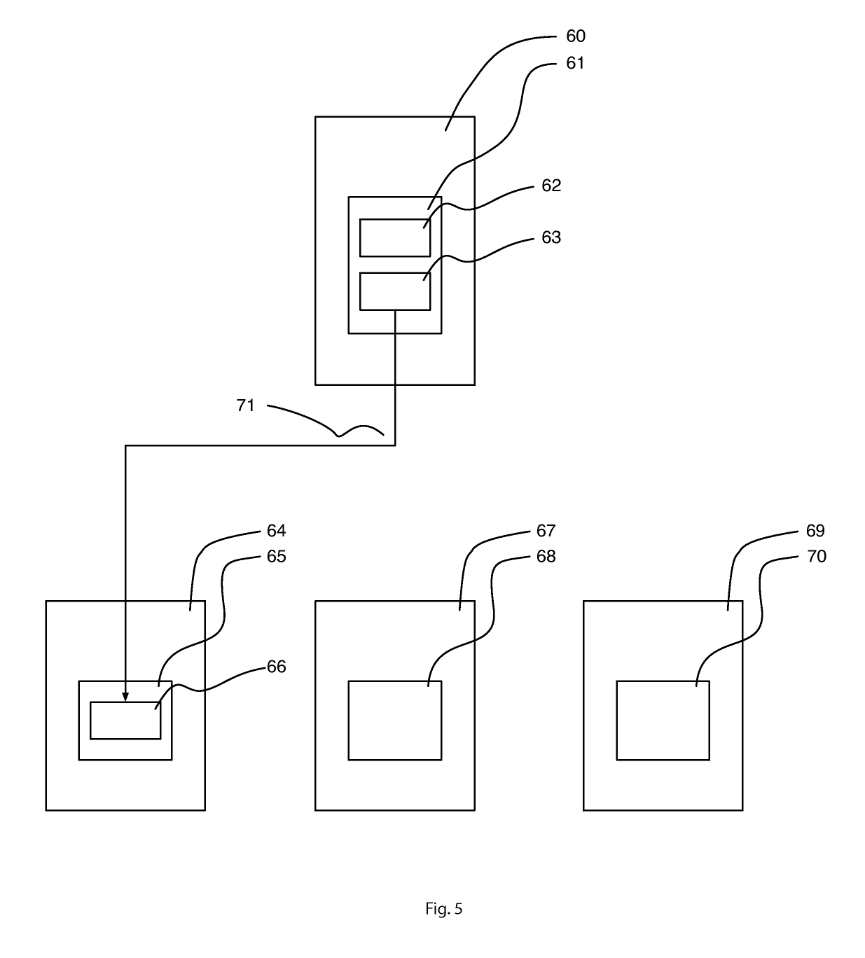

FIG. 5 illustrates an initiation of message 71 intended for one recipient by message creator 62 sent wirelessly by message sender 63 within the software messaging application service 61 in the wireless mobile data server 60 which is received by the client messaging receptor 66 within the client software messaging application 65 within the client device 64. This is an example of software messaging service of none-to-one.

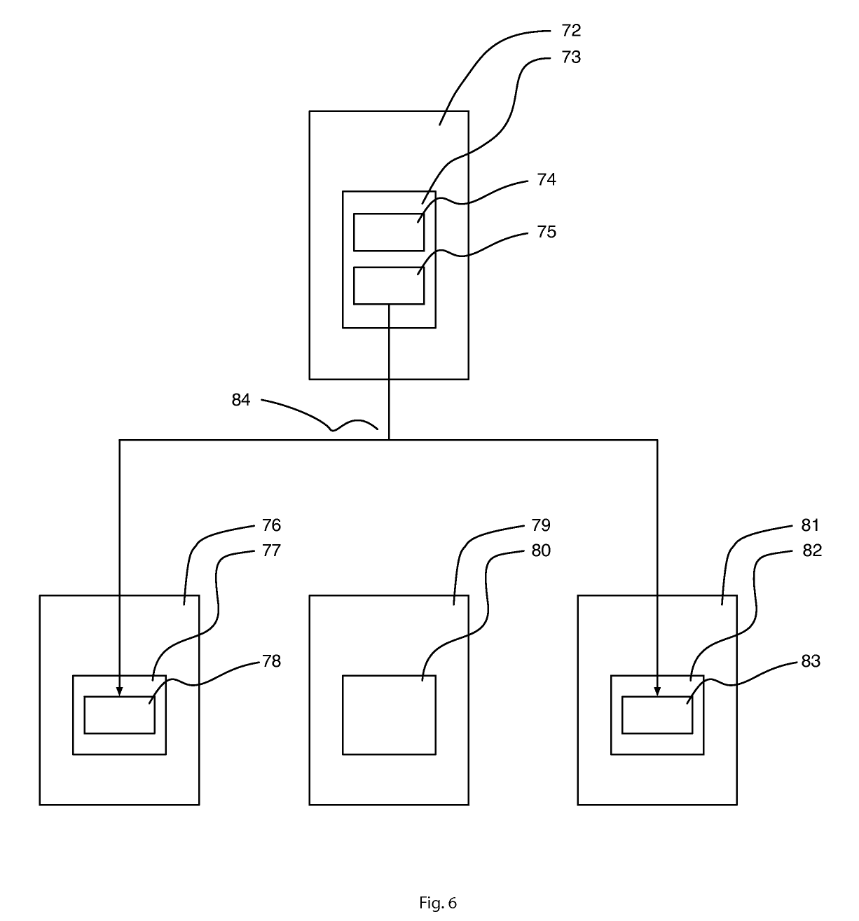

FIG. 6 illustrates an initiation of message 84 in the message creator 74 and transmitted by message transmitter 75 in the software messaging application service 73 within the wireless mobile data server 72 intended for multiple client devices 76,81 and received by client messaging receptors 78,83. This is an example of software message service of none-to-many.

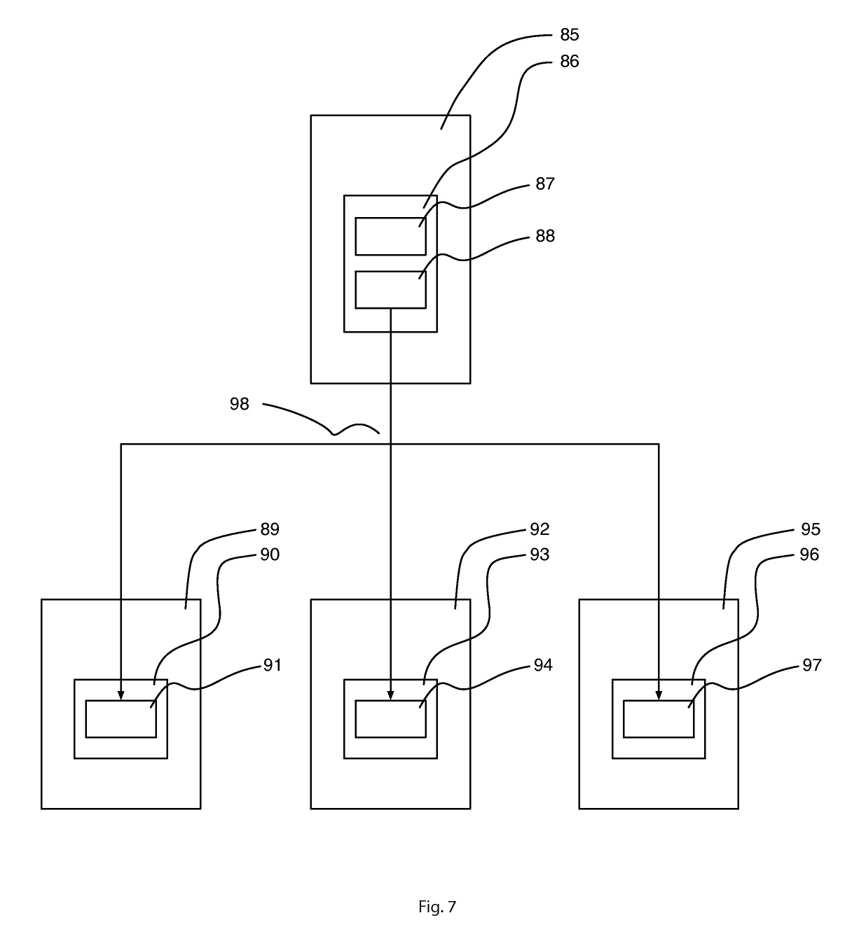

FIG. 7 illustrates an initiation of message 98 by software message creator 87 and transmission by message transmitter 88 within the software messaging application 86 within. the wireless mobile data server 85. Message 98 is received by all clients 89,92,95 by the clients software message receptors 91,94,97 within the client's software messaging applications 90,93,96. This is an example of software message service of none-to-all.

What is claimed is:

1. A battery operated mobile data server capable of transmitting and receiving data to and from multiple mobile devices such as smartphones, tablet computers, netbooks and notebook computers using dissimilar operating systems.

2. An application code processing environment resident in hardware or firmware or hardware and firmware of a battery operated mobile wireless data server that is capable of querying data, editing data, analyzing data, calculating data, encrypting and decrypting data, distributing data to connected mobile devices, retrieving data resident on the solid-state memory module and writing data to the solid-state memory module.

3. An software application messaging service resident in a battery operated mobile wireless data server that is capable of receiving, creating, processing, encrypting decoding and distributing messages to all or selected connected mobile devices.
